(19) United States
(12) Patent Application Publication
(10) Pub. No.: US 2018/0005360 A1
(43) Pub. Date: Jan. 4, 2018

(54) METHOD AND SYSTEM FOR PATTERN CORRECTION OF BOREHOLE IMAGES THROUGH IMAGE FILTERING

(71) Applicant: Schlumberger Technology Corporation, Sugar Land, TX (US)

(72) Inventors: Clement Probel, Clamart (FR); Josselin Kherroubi, Clamart (FR); Roel Van Os, Clamart (FR); Richard Bloemenkamp, Clamart (FR)

(21) Appl. No.: 15/629,776

(22) Filed: Jun. 22, 2017

(30) Foreign Application Priority Data
Jun. 30, 2016 (EP) 16290123.5

(51) Int. Cl. G06T 5/10; G06T 5/20

(52) U.S. Cl. CPC G06T 5/10; G06T 5/20; G06T 2207/20024

(57) ABSTRACT

In one embodiment, a computer-based method includes obtaining a first image where the first image includes one or more patterns, generating a second image that substantially removes or reduces the one or more patterns from the first image at least partially by automatically detecting the one or more patterns and a zone where the one or more patterns occur in the first image, converting the first image to frequency domain data, applying a multi-parameter filter to the frequency domain data to substantially remove or reduce the one or more patterns. The parameters may include bandwidths in a depth and azimuthal direction. The parameters may be adapted in the multi-parameter filter based on the one or more patterns. The method also includes transforming the frequency domain data to spatial domain data and outputting the second image based at least in part on the spatial domain data.

### CROSS-REFERENCE TO RELATED APPLICATIONS

The present application claims priority to EP Application No. 16290123.5, which was filed on Jun. 30, 2016, and is incorporated herein by reference in its entirety.

### BACKGROUND

This disclosure relates to a method and system for filtering borehole images with regularly recurring patterns.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as an admission of any kind.

Wells are generally drilled into a surface (land-based) location or ocean bed to recover natural deposits of oil and natural gas, as well as other natural resources that are trapped in geological formations. A well may be drilled using a drill bit attached to the lower end of a “drill string,” which includes a drill-pipe, a bottom hole assembly, and other components that facilitate turning the drill bit to create a borehole. For oil and gas exploration and/or monitoring, it may be desirable to obtain information about the subsurface formations that are penetrated by a borehole for analysis. More specifically, this may include obtaining downhole measurements and generating images that visualize characteristics of the subsurface formations.

Borehole rugosity may affect logging measurements, which may result in unclear images with artifacts. In some instances, drilled boreholes may take the shape of a corkscrew and logged images may contain a periodic artifact which degrades log interpretation (e.g., detection of fractures, dip picking). Additionally, during the drilling process, the drill bit may at certain times create marks in the subsurface formation due to the scratching of separate cones of the drill bit. These drill-marks may also hamper image interpretation.

### SUMMARY

This summary is provided to introduce a selection of concepts that are further described below in the detailed description. This summary is not intended to identify key or essential features of the subject matter described herein, nor is it intended to be used as an aid in limiting the scope of the subject matter described herein. Indeed, this disclosure may encompass a variety of aspects that may not be set forth below.

Systems and methods are provided for rugosity correction of borehole images through image filtering. An example of a computer-based method includes obtaining a first image where the first image includes one or more patterns, generating a second image that substantially removes or reduces the one or more patterns from the first image at least partially by automatically detecting the one or more patterns and a zone where the one or more patterns occur in the first image, converting the first image to frequency domain data, applying a multi-parameter filter to the frequency domain data to substantially remove or reduce the one or more patterns. The first parameter of the multi-parameter filter relates to a bandwidth in a depth direction and a second parameter of the multi-parameter filter relates to a bandwidth in an azimuthal direction. The first parameter, the second parameter, or both are automatically adapted in the multi-parameter filter based on the one or more patterns. The method also includes transforming the frequency domain data to spatial domain data and outputting the second image based at least in part on the spatial domain data.

An example of a system may include a downhole tool in a wellbore of a geological formation, and a data processing system comprising a processor. The processor is configured to obtain a borehole image deriving from the downhole tool where the borehole image includes one or more artifacts and to generate a filtered image that substantially removes or reduces the one or more artifacts from the borehole image at least partially by determining a location of the one or more artifacts and a zone where the one or more artifacts occur in the borehole image, converting the borehole image to frequency domain data, applying a multi-parameter filter to the frequency domain data to substantially remove or reduce the one or more artifacts, and transform the frequency domain data to spatial domain data. The processor is also configured to output the filtered image based at least in part on the spatial domain data.

Various refinements of the features noted above may be undertaken in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a schematic diagram of a well-logging system that employs a data processing system, in accordance with an embodiment;

FIG. 2 illustrates a three-dimensional view of a vertical spiral wellbore;

FIG. 3 illustrates a sectional view of the vertical spiral wellbore of FIG. 2;

FIG. 4 is an illustration of a logging-while-drilling (LWD) resistivity image and a LWD density image generated from a vertical spiral wellbore;

FIG. 5 is a flow diagram of a process for filtering in a frequency domain, in accordance with an embodiment;

FIG. 6 is an illustration of a resistivity image and synthetic images where a two-dimensional discrete sinusoid is added, in accordance with an embodiment;

FIG. 7 is an illustration of Discrete Fourier Transform (DFT) magnitudes plotted of the images of FIG. 3, in accordance with an embodiment;

FIG. 8 is an illustration of two-dimensional representations of highpass filters, such as Ideal, Butterworth, and Gaussian, in accordance with an embodiment;

FIG. 9 is a graph illustrating the cross section of highpass filters for Ideal, Butterworth of order three and Gaussian, in accordance with an embodiment;

FIG. 10 is an illustration of restored images obtained after computing the Inverse Discrete Fourier Transform (IDFT) of the filtered DFT, in accordance with an embodiment;

FIG. 11 is an illustration of resistivity images for vertical spiral wellbores and their corresponding DFT, in accordance with an embodiment;

FIG. 12 is an illustration of a one-dimensional Gaussian highpass filter and a two-dimensional Gaussian highpass filter, in accordance with an embodiment;

FIG. 13 is an illustration of resistivity images obtained by a LWD downhole tool before and after spirals are reduced, in accordance with an embodiment;

FIG. 14 is an illustration of density images obtained by a LWD downhole tool before and after spirals are reduced, in accordance with an embodiment;

FIG. 15 is an illustration of a resistivity image obtained by a wireline downhole tool with pads before and after spirals are reduced, in accordance with an embodiment;

FIG. 16 is a flow diagram of a process for generating and outputting a filtered image, in accordance with an embodiment;

FIG. 17 is an illustration of a zone selected and a line drawn on a spiral by a user, in accordance with an embodiment;

FIG. 18 is an example of graphical elements used by the user to select the filter strength, in accordance with an embodiment;

FIG. 19 is an illustration of images of a borehole wall including drill marks obtained by a wireline downhole tool, in accordance with an embodiment;

FIG. 20 is an illustration of images of a borehole wall including drill marks present in two directions leading to dots obtained by a wireline downhole tool, in accordance with an embodiment;

FIG. 21 is an illustration of images of a borehole wall including scratch marks obtained by a wireline downhole tool, in accordance with an embodiment;

FIG. 22 is an illustration of a pad image obtained by a wireline tool before and after drill marks are filtered, in accordance with an embodiment; and

FIG. 23 is an illustration of pad images obtained by a wireline tool before and after two types of drill marks are filtered, in accordance with an embodiment.

### DETAILED DESCRIPTION

One or more specific embodiments of the present disclosure will be described below. These described embodiments are examples of the presently disclosed techniques. Additionally, in an effort to provide a concise description of these embodiments, features of an actual implementation may not be described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would still be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

In certain drilling conditions, boreholes may take the shape of a helix. This may be referred to as borehole spiraling or corkscrewing, and it is a common type of borehole oscillation or rugosity. In the context of an oil field, rugosity pertains to a borehole whose diameter changes rapidly with depth. Corkscrewing is mainly caused by the lateral movement of poorly stabilized Bottom Hole Assemblies (BHA). Corkscrewing may affect boreholes drilled with either BHA or steerable motors. Further, the use of Rotary Steerable Systems (RSS) may result in better quality boreholes but may still result in borehole spiraling. Like other types of rugosity, borehole spiraling may affect logging measurements which are sensitive to standoff. Standoff is the distance between the external surface of a downhole tool and the borehole wall. Additionally, drill-marks and scratches to the borehole wall may appear as artifacts on certain images, which may also affect interpretation of the images (e.g., detection of fractures, dip picking).

Accordingly, embodiments of the present disclosure generally relate to an image-processing process for periodic noise filtering to efficiently reduce the features generated on borehole images by the above spiraling, drill-marking, and scratching. The filtered images may substantially remove these undesirable features to enable correct interpretation by a user (e.g., geologist). Although the following discussion focuses on removing artifacts (e.g., spirals (corkscrew signatures), drill-mark signatures, scratches) in images obtained from a borehole, it should be appreciate that the disclosed techniques may be applicable to filtering any images that include regularly recurring patterns (e.g., vertical or horizontal bars, dots, swirls, zig-zags, squares, triangles, circles, octagons, hexagons).

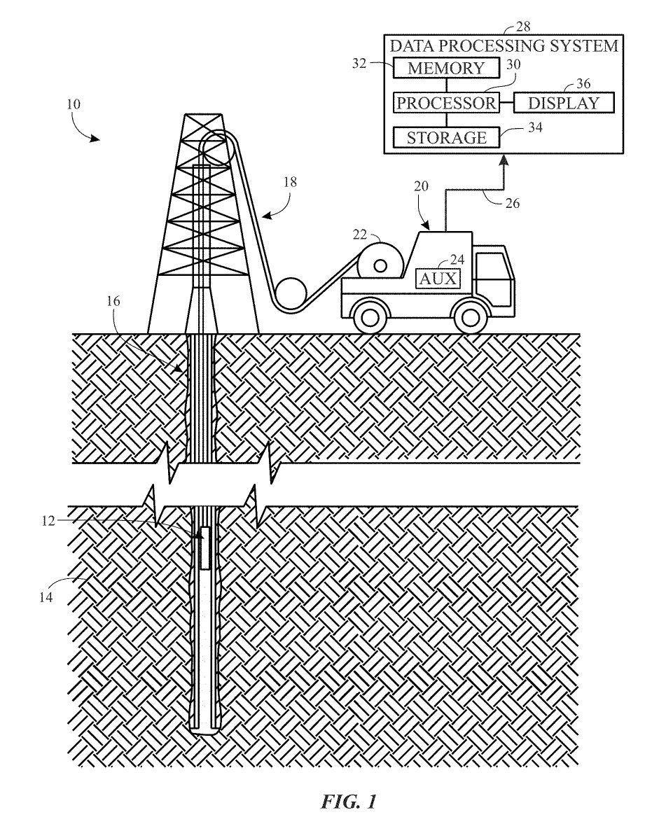

With this in mind, FIG. 1 illustrates a well-logging system 10 that may be used to convey a downhole tool 12 through a geological formation 14 via a wellbore 16. The downhole tool 12 is conveyed on a cable 18 via a logging winch system 20. Although the logging winch system 20 is schematically shown in FIG. 1 as a mobile logging winch system carried by a truck, the logging winch system 20 may be substantially fixed (e.g., a long-term installation that is substantially permanent or modular). Any suitable cable 18 for well logging may be used. The cable 18 may be spooled and unspooled on a drum 22 and an auxiliary power source 24 may provide energy to the logging winch system 20 and/or the downhole tool 12.

Although the downhole tool 12 is described as a wireline downhole tool, it should be appreciated that any suitable conveyance may be used. For example, the downhole tool 12 may instead be conveyed as a logging-while-drilling (LWD) tool as part of a bottom hole assembly (BHA) of a drill string, conveyed on a slickline or via coiled tubing, and so forth. For the purposes of this disclosure, the downhole tool 12 may be any suitable measurement tool that uses electrical sensors to obtain measurements of the wellbore 16 wall.

As discussed further below, the downhole tool 12 may include a number of sensors used to acquire data 26 about the wellbore 16 and/or geological formation 14 by taking measurements. For example, the data 26 may be images of the wellbore 16 obtained via sensor pads. The data 26 may be sent to a data processing system 28. The data processing system 28 may analyze the data 26 to filter any spiraling, drill-marks, scratches, or the like from the images of the borehole wall and output a filtered image, among other things. The data processing system 28 may be any electronic data processing system that can be used to carry out the systems and methods of this disclosure. For example, the data processing system 28 may include a processor 30, which may execute instructions stored in memory 32 and/or storage 34. As such, the memory 32 and/or the storage 34 of the data processing system 28 may be any suitable article of manufacture that can store the instructions. The memory 32 and/or the storage 34 may be ROM memory, random-access memory (RAM), flash memory, an optical storage medium, or a hard disk drive, to name a few examples. A display 36, which may be any suitable electronic display, may display the images generated by the processor 30. The data processing system 28 may be a local component of the logging winch system 20, a remote device that analyzes data from other logging winch systems 20, or partly local and partly remote. In some embodiments, the data processing system 28 may be a mobile computing device (e.g., tablet, smartphone, or laptop) or a server remote from the logging winch system 20.

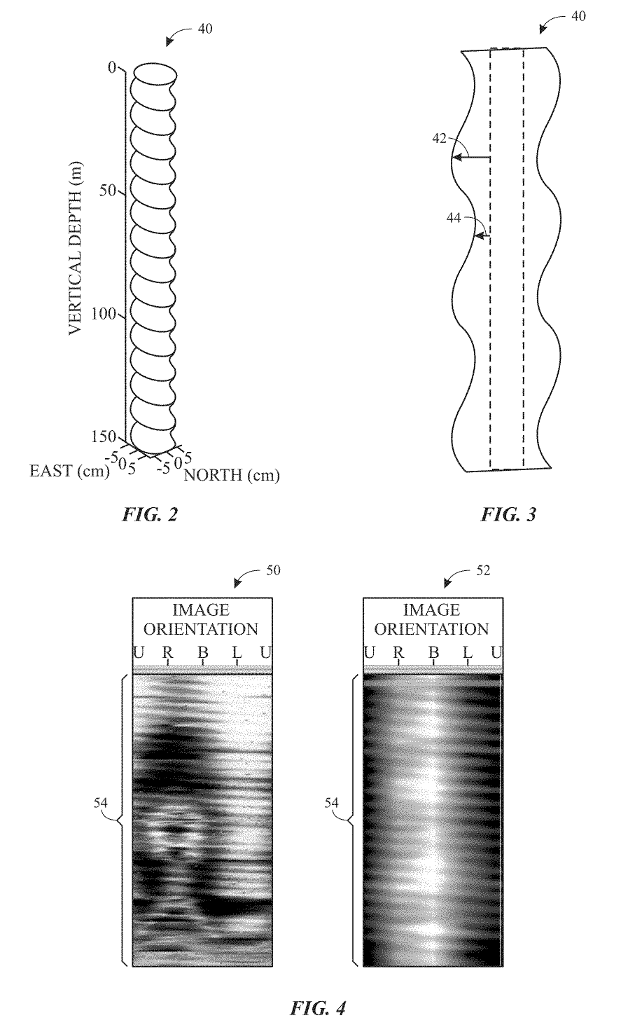

As discussed above, borehole spiraling may affect logging measurements that are sensitive to standoff. To illustrate the issue more clearly, FIG. 2 depicts a three-dimensional view of a vertical spiral wellbore 40 and FIG. 3 depicts a sectional view of the vertical spiral wellbore 40 of FIG. 2. The corkscrew shape of the vertical spiral wellbore 40 may be caused by the lateral movements of a poorly stabilized bit during drilling. The corkscrew shape results in standoff that varies depending on depth, as shown by arrows 42 and 44 in FIG. 3. That is, arrow 42 represents a standoff that is greater at a different depth than the standoff represented by arrow 44. The effect of constant standoff is usually compensated for, not the effect of depth-dependent standoff, like observed in the vertical spiral (rugose) wellbore 40. Corkscrewing equally affects both logging-while-drilling (LWD) and wireline (WL) measurements.

Thus, some embodiments of the present disclosure include the processor 30 performing image-processing to substantially remove or reduce certain artifacts on an image. The embodiments described below are described as applying to various types of images, such as LWD resistivity images, LWD density images, WL resistivity images, and so forth, but it should be appreciated that any image with regularly recurring patterns may benefit from the present disclosure.

In some embodiments, frequency domain filtering using Discrete Fourier Transform (DFT) may be used to substantially remove any undesirable features of an image. The filtering may be performed by the processor 30 with relatively few inputs, as described below. Filtering in the frequency domain may include modifying the DFT of an image to achieve a specific objective and then computing the inverse transform to obtain the processed result.

For example, a digital image of size M×N is a numerical array f(x, y) of variables x=0, 1, . . . , M−1 and y=0, 1, . . . , N−1. Elements off may be referred to as pixels. The two-dimensional (2-D) DFT of f is expressed as:

$$F ( u , v ) = {\sum }_{x = 0}^{M - 1} {\sum }_{y = 0}^{N - 1} f ( x , y ) {e}^{- j 2 π ( \frac{ux}{M} + \frac{vy}{N} )} \qquad ( Equation 1 )$$

for u=0, 1, . . . , M−1 and v=0, 1, . . . , N−1. In some embodiments, given the transform F(u, v), the processor 30 may obtain f(x, y) without loss of information, by using the Inverse Discrete Fourier Transform (IDFT):

$$F ( x , y ) = \frac{1}{MN} {\sum }_{u = 0}^{M - 1} {\sum }_{v = 0}^{N - 1} f ( u , v ) {e}^{j 2 π ( \frac{ux}{M} + \frac{vy}{N} )} \qquad ( Equation 2 )$$

for x=0, 1, . . . , M−1 and y=0, 1, . . . , N−1.

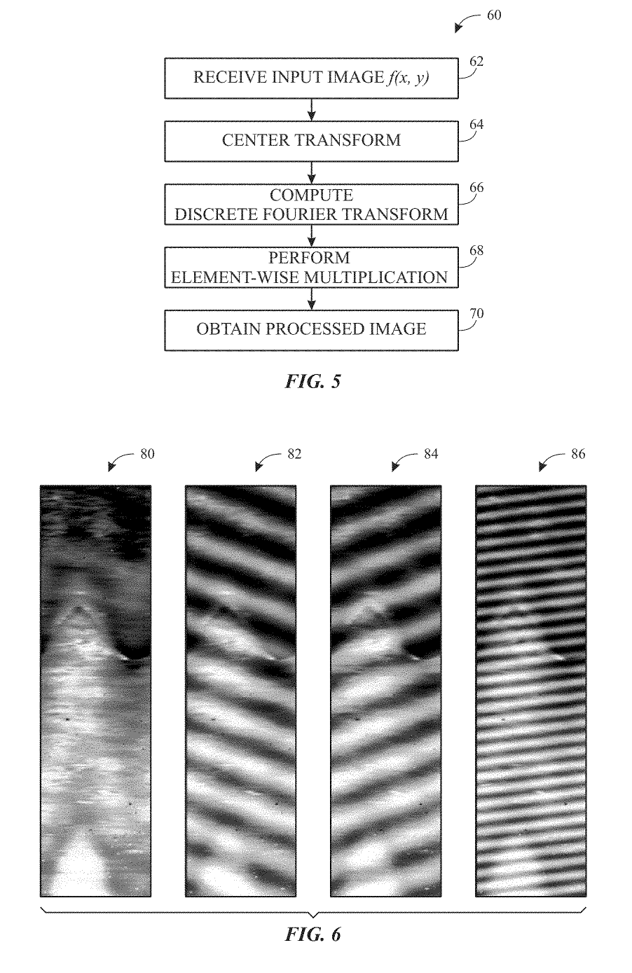

FIG. 5 is a flow diagram of a process 60 for filtering in a frequency domain, in accordance with an embodiment. Although the following description of the process 60 is described as being performed by the processor 30 of the data processing system 28, it should be noted that the method 60 may be performed by other processors disposed on other devices that may be capable of communicating with the data processing system 28 and/or the downhole tool 12, such as a computing device or other component associated with the well-logging system 10. Additionally, although the following method 60 describes a number of operations that may be performed, it should be noted that the method 60 may be performed in a variety of suitable orders and some of the operations may not be performed. It should be appreciated that the method 60 may be wholly executed by the data processing system 28 or the execution may be distributed between another computing device (e.g., downhole tool 12) and the data processing system 28. It should be noted that the method 60 may be implemented as computer instructions stored on the memory 32 and/or storage 34.

Referring now to the method 60, the processor 30 may receive (block 62) an input image f(x, y) of size M×N. In some embodiments, the processor 30 may multiply f(x, y) by (−1)^{x+y} to center (block 64) its transform. Although centering helps visualizing the filtering process, some embodiments may be performed without centering. The processor 30 may compute (block 66) the DFT, F(u, v). Further, the processor 30 may perform (block 68) element-wise multiplication. That is, the processor 30 may multiply the DFT by a real, symmetric about its center, filter function H(u, v) of size M×N:

G(u,v)=H(u,v)F(u,v) (Equation 3)

The processor 30 may also obtain (block 70) a processed imaged:

g(x,y)=real(τ⁻¹(G(u,v)))(−1)^{x+y} (Equation 4)

where τ⁻¹ is the IDFT.

One goal of some embodiments may be to neither remove more than the artifact frequency, nor add unwanted noise to an image. Accordingly, in some embodiments, the processor 30 may use synthetic images to highlight more clearly the frequency components of artifacts (e.g., spirals, scratches, drill-marks) to remove. FIG. 6 is an illustration of a resistivity image 80 and synthetic images 82, 84, and 86 where a two-dimensional (2D) discrete sinusoid is added, in accordance with an embodiment. The 2D sinusoid is given by:

$$s ( x , y ) = sin ( 2 π ( \frac{{u}^{′}}{M} x + \frac{{v}^{′}}{N} y ) ) \qquad ( Equation 5 )$$

where parameters u′ and v′ are the sine frequencies along the vertical and horizontal axes, respectively. In the particular case of a helix, |v′|=1. The sign of v′ is the spiral direction (sense of rotation). As depicted, synthetic images 82 and 84 have opposite spiral directions, and thus, the sign of v′ is reversed when the processor 30 adds the 2D discrete sinusoid to the resistivity image 80 to generate each of the synthetic images 82 and 84.

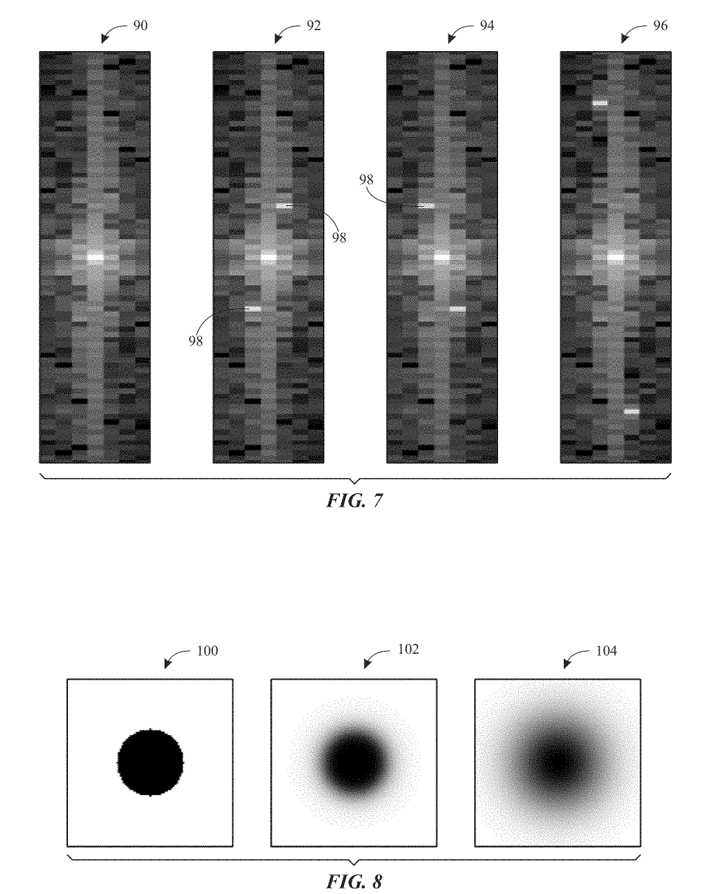

The processor 30 may convert the images 80, 82, 84, and 86 from the spatial domain to the frequency domain by applying the DFT. For example, FIG. 7 is an illustration of the magnitudes of the centered DFT of the images 80, 82, 84, and 86 of FIG. 6 plotted in images 90, 92, 94, and 96, respectively, in accordance with an embodiment. The 2D sinusoid may be transformed into two strong symmetric impulses in the frequency domain. Indeed, the DFT of s(x, y) is given by:

S(u,v)=j½(δ(u+u′,v+v′)−(u−u′,v−v′)) (Equation 6)

where δ is a Dirac delta function. On a centered DFT, the position of the bursts may be modified into:

$$( {u}^{′} + \frac{M}{2} , {v}^{′} + \frac{N}{2} ) , ( - {u}^{′} + \frac{M}{2} , - {v}^{′} + \frac{N}{2} ) \qquad ( Equation 7 )$$

The symmetric bursts may be removed by using notch filtering. Notch reject filters are constructed as products of highpass filters whose centers have been translated to the centers of the bursts. In some embodiments, the highpass filters may include:

$$\begin{matrix}Ideal filter \text{:} H ( u , v ) = \{ \begin{matrix}1 & if D > {D}_{0} \\ 0 & otherwise\end{matrix} & ( Equation 8 ) \\ Butterworth filter \text{:} H ( u , v ) = \frac{1}{1 + {( \frac{{D}_{0}}{D ( u , v )} )}^{2 n}} & ( Equation 9 ) \\ Gaussian filter \text{:} H ( u , v ) = 1 - {e}^{- \frac{{D ( u , v )}^{2}}{2 {D}_{0}^{2}}} & ( Equation 10 )\end{matrix}$$

where D₀ is the cutoff frequency, n the order of the Butterworth filter, and D(u, v)=\sqrt{(u−u₀)²+(v−v₀)²} the distance from the center (u₀,v₀) of the filter. The value of the cutoff may be selected by visual inspection of the DFT to encompass the energy bursts completely. It should be noted that, in some embodiments, multiplying the frequency domain by the selected filter may include multiplying the regions with energy bursts (e.g., regions 98) by zero and the remaining regions by one. In this way, the regions with energy bursts that may represent an undesirable artifact may be substantially removed. In some embodiments, for example where drill-marks are being filtered out, the values of the regions with the energy bursts may be replaced with values of the regions surrounding the white dot regions (e.g., instead of being multiplied by zero). That is, interpolation may be used to modify the values of the regions with energy bursts, thereby substantially removing or reducing the undesirable artifact.

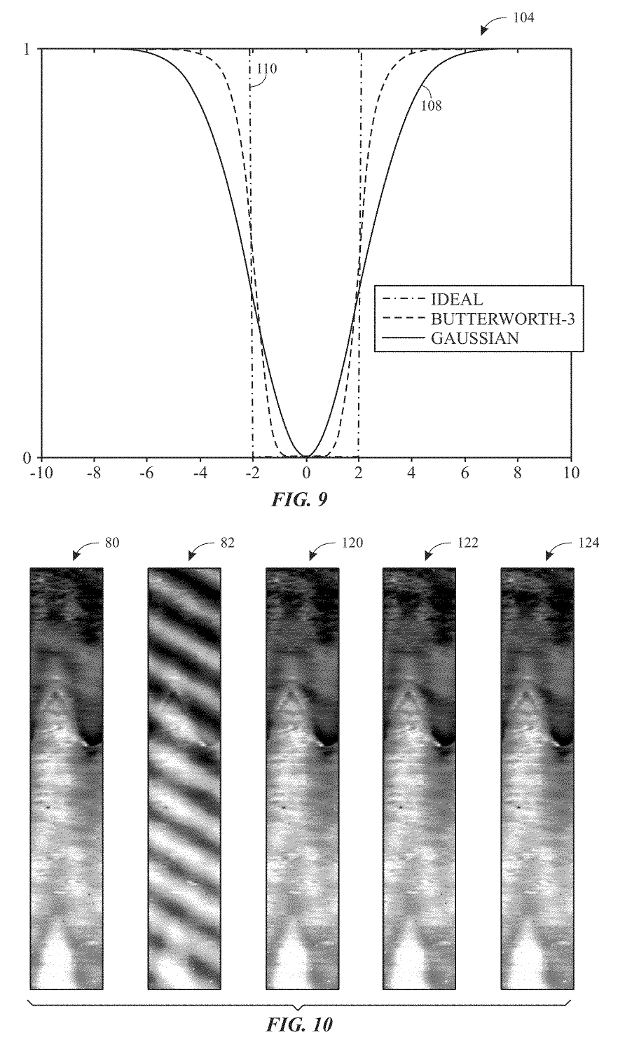

FIG. 8 is an illustration of two-dimensional representations 100, 102, and 104 of the highpass filters, such as Ideal, Butterworth, and Gaussian, respectively, and FIG. 9 is a graph 106 illustrating the cross section of the highpass filters, in accordance with an embodiment. As depicted, the representation 104 of the Gaussian filter is the blurriest of the three filter representations 100, 102, and 104, and the representation 100 of the Ideal filter is the most clear of the three filter representations 100, 102, and 104. This is also evident in the graph 106 where a curve 108 representing the Gaussian filter increases from 0 to 1 gradually over approximately 6 units away from the center and a curve 110 representing the Ideal filter increases from 0 to 1 immediately at 2 units away from the center. After the filter is applied to the images 90, 92, 94, and 96, the filtered images may be transformed back to the spatial domain using the IFDT.

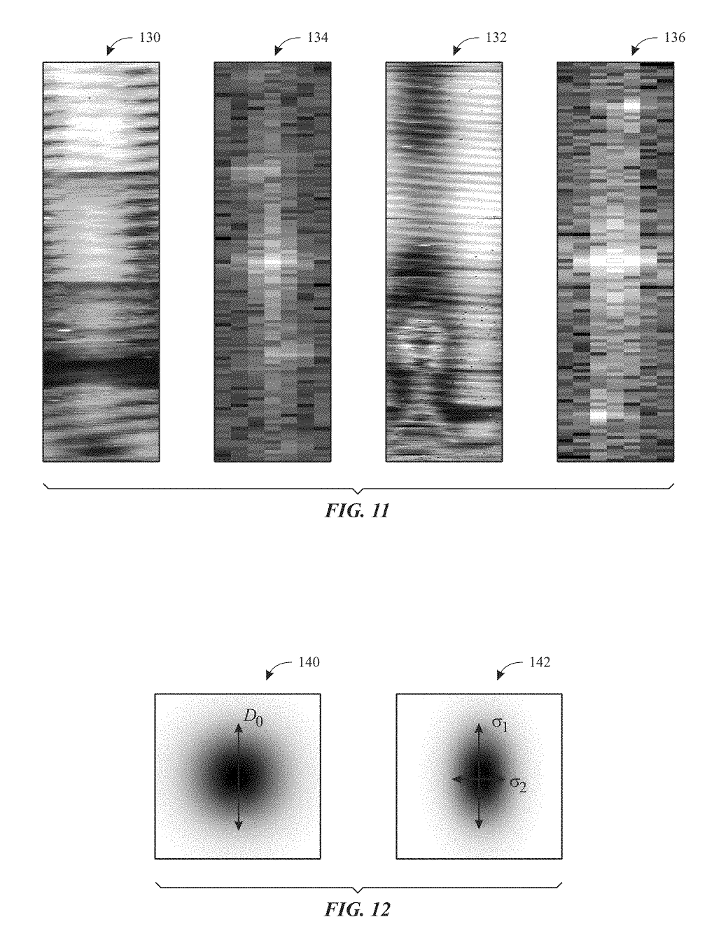

Accordingly, FIG. 10 is an illustration of restored images 120, 122, and 124 obtained after computing the Inverse Discrete Fourier Transform (IDFT) of the filtered DFT, in accordance with an embodiment. Image 120 is restored using the IDFT after applying the Ideal filter to the image 92, image 122 is restored using the IDFT after applying the Butterworth filter to the image 94, and image 124 is restored using the IDFT after applying the Gaussian filter to the image 96. In this synthetic example, the three filters yield equally good results, as there does not appear to be noticeable differences between the original image 80 and the restored images 120, 122, and 124. It should also be appreciated that the formation features are much more ascertainable in the restored images 120, 122, and 124 than, for example, the synthetic image 82 where the spiral artifact is present. Using the restored images 120, 122, and 124, the processor 30 may apply additional algorithms, such as dip picking or any other feature-extraction algorithm.

Turning now to real images, as opposed to synthetic ones, FIG. 11 is an illustration of resistivity images 130 and 132 for vertical spiral wellbores and their corresponding DFT 134 and 136, in accordance with an embodiment. As depicted, the frequency domain bursts in the DFTs 134 and 136 are not as sharp as in the synthetic case (e.g., images 90, 92, 94, and 96 in FIG. 7) and their extension varies from one image to the other. For example, the circle-shaped one-parameter filters of FIG. 8 may not be suitable for the DFT 136 of FIG. 11 because the bursts mainly extend in the vertical direction. That is, in this particular instance, a circular filter may remove too much frequency content in the neighboring columns.

As such, in some embodiments, ellipse-shaped two-parameter notch filters may be used. For example, the Gaussian highpass filter may be generalized in two-dimensions as:

$$H ( u , v ) = 1 - {e}^{- \frac{{( u - {u}_{0} )}^{2}}{2 {σ}_{1}^{2}} - \frac{{( v - {v}_{0} )}^{2}}{2 {σ}_{2}^{2}}} \qquad ( Equation 11 )$$

The two-parameter Gaussian notch filter may add flexibility in the filtering process. To illustrate, FIG. 12 depicts a one-dimensional Gaussian highpass filter 140 and a two-dimensional Gaussian highpass filter 142, in accordance with an embodiment. The filter parameters σ₁ and σ₂ of the two-dimensional Gaussian highpass filter 142 are computed directly from the DFT to substantially remove the energy bursts (e.g., not more and not less), such that σ₁ covers the noise peak bandwidth in the depth direction and σ₂ covers the noise peak bandwidth in the azimuthal direction. It should be noted that computing the filter 142 may be performed by the processor 30 automatically (e.g., without user input). In some embodiments, the bandwidth of the filter 142 may be automatically or manually adapted in the depth direction and/or in the azimuthal directions based on a detected noise shape in the frequency domain. It should be noted that the filter 142 may include parameters (e.g., a multi-parameter filter) in addition to the azimuthal bandwidth parameter and the depth-direction bandwidth parameter, such as an azimuthal central spatial frequency, a depth-direction central spatial frequency, and a filter strength, as described herein.

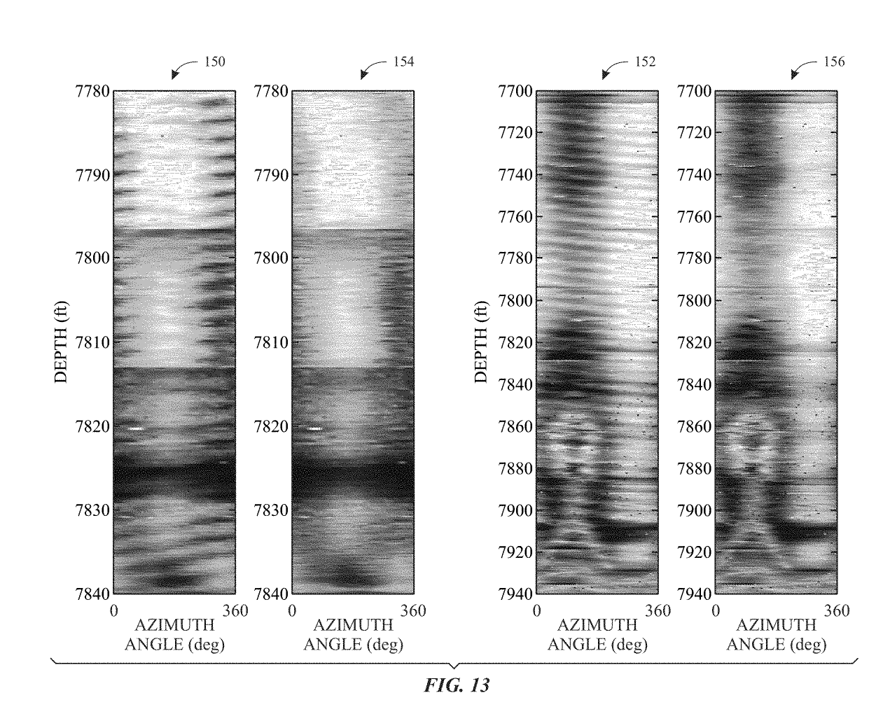

The two-parameter Gaussian notch filter 142 described above was tested on numerous borehole images, four different measurements (resistivity, density, ultrasonic, photoelectric), and different tools (LWD downhole tool and WL downhole tool). The images include differing spiral properties, such as a corkscrew period (pitch of helix) from one to six feet, left- and right-dipping (clockwise and counter-clockwise), and window size from twenty to four hundred feet. FIGS. 13, 14, and 15 represent some results of the tests using the filtering described herein. As shown in FIGS. 13, 14, and 15, the oscillation pattern has been substantially removed from the original images, without attenuating formation features of interest or introducing unwanted noise. As such, image quality and interpretation ability have been significantly improved.

In particular, FIG. 13 is an illustration of resistivity images 150 and 152 obtained by a LWD downhole tool 12 before and after spirals are reduced (filtered resistivity images 154 and 156), in accordance with an embodiment. As depicted in the resistivity image 150, the spiral is left-dipping (clockwise downward rotation), the window is sixty feet, and the corkscrew period is between approximately three to six feet. The filtered resistivity image 154 that results after the spiral is substantially removed or reduced by the processor 30 using the disclosed techniques provides a more interpretable image. Additionally, as depicted in the resistivity image 152, the spiral is right-dipping (counter-clockwise downward rotation), the window is two-hundred forty feet, and the corkscrew period is between approximately one to three feet. The filtered resistivity image 156 that results after the spiral is substantially removed or reduced provides a more interpretable image.

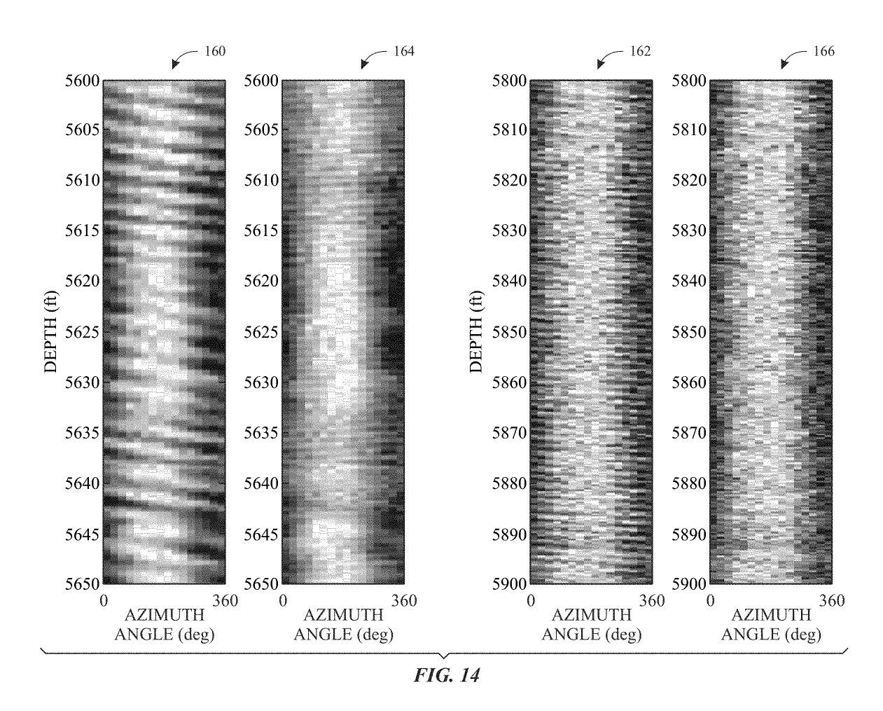

FIG. 14 is an illustration of density images 160 and 162 obtained by a LWD downhole tool 12 before spirals are reduced and corresponding filtered density images 164 and 166 after spirals are reduced, in accordance with an embodiment. As depicted in the density image 160, the spiral is right-dipping (counter-clockwise downward rotation), the window is fifty feet, and the corkscrew period is between approximately four to six feet. The filtered density image 154 that results after the spiral is substantially removed or reduced by the processor 30 using the disclosed techniques provides a more interpretable image. Additionally, as depicted in the density image 162, the spiral is right-dipping (counter-clockwise downward rotation), the window is one hundred feet, and the corkscrew period is between approximately one to two feet. The filtered image 156 that results after the spiral is substantially removed or reduced provides a more interpretable image.

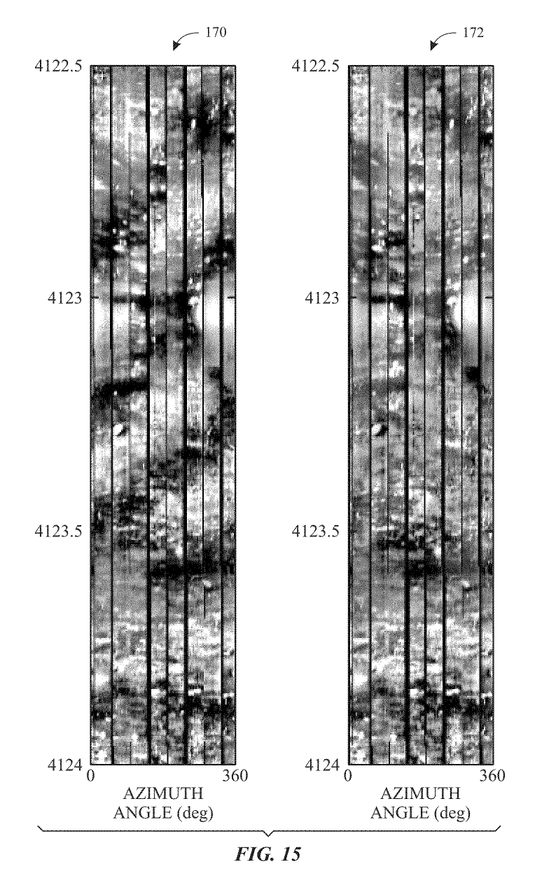

FIG. 15 is an illustration of a resistivity image 170 obtained by a wireline (WL) downhole tool 12 with pads before and after spirals are reduced (filtered resistivity image 172), in accordance with an embodiment. In the depicted embodiment, the WL downhole tool 12 includes pads that acquire data with absent values as all azimuth angles cannot be scanned by the pads. In this instance, the filtering process may be applied on an interpolated image. As depicted in the resistivity image 170, the spiral is left-dipping (clockwise downward rotation), the window is one and a half feet, and the corkscrew period is approximately one foot. The filtered resistivity image 172 that results after the spiral is substantially removed or reduced by the processor 30 using the disclosed techniques provides a more interpretable image.

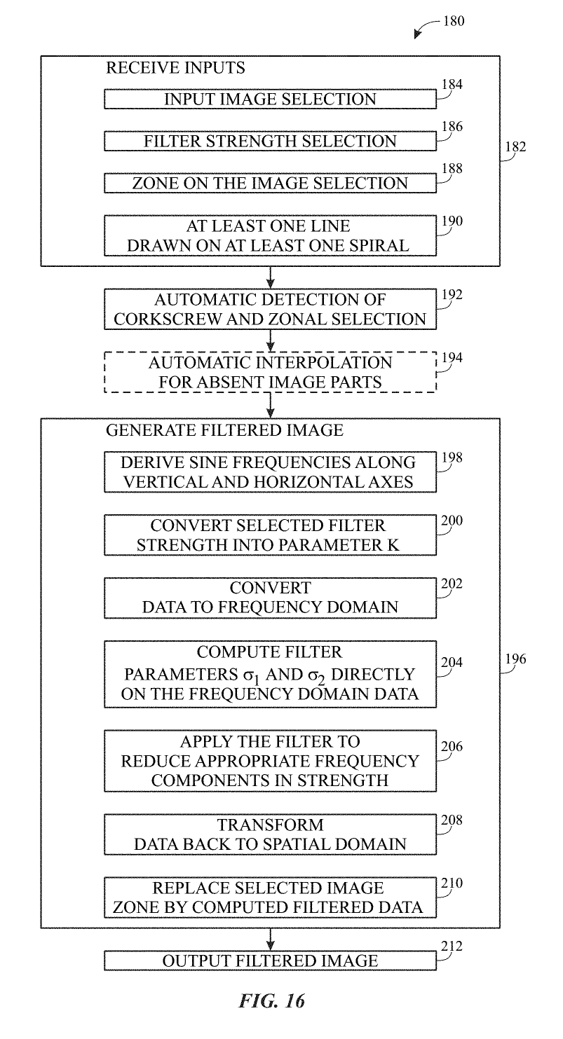

FIG. 16 is a flow diagram of a process 180 for generating and outputting a filtered image (e.g., resistivity, density, ultrasonic, photoelectric), in accordance with an embodiment. Although the following description of the process 180 is described as being performed by the processor 30 of the data processing system 28, it should be noted that the process 180 may be performed by other processors disposed on other devices that may be capable of communicating with the data processing system 28 and/or the downhole tool 12, such as a computing device or other component associated with the well-logging system 10. Additionally, although the following process 180 describes a number of operations that may be performed, it should be noted that the process 180 may be performed in a variety of suitable orders and all of the operations may not be performed. It should be appreciated that the process 180 may be wholly executed by the data processing system 28 or the execution may be distributed between another computing device (e.g., downhole tool 12) and the data processing system 28. It should be noted that the process 180 may be implemented as computer instructions stored on the memory 32 and/or storage 34.

Referring now to the process 180, the processor 30 may receive (block 182) one or more inputs. The inputs may include an input image selection (data 184), a filter strength selection (data 186), a zone on the image selection (data 188), at least one line drawn on at least one spiral of the image (data 190). In some embodiments, not all of the inputs may be received by the processor 30. For example, in some embodiments, just the input image selection (data 184) and the filter strength selection (data 186) may be received as inputs from a user.

In such embodiments, where just the input image selection (data 184) and the filter strength selection (data 186) are received as inputs, the processor 30 may perform (block 192) automatic corkscrew (spiral) detection and zonal selection. Automatic corkscrew detection may be performed by the processor 30 by scanning different possible angles of the pattern on the image and identifying the pixels in the frequency domain where corkscrew could occur. Subsequently, the processor 30 may perform peak detection, which provides a possibility to compute a corkscrew probability. The corkscrew probability may identify the zone where corkscrew patterns occur. This automated step (block 192) may be performed by the processor 30 without the user inputting the selection of the zone on the image (data 188) or drawing at least one line on at least one spiral on the image (data 190).

The processor 30 may also perform (dashed block 194) automatic interpolation for absent image parts. This step may be optional depending on the type of downhole tool 12 that is used to obtain the image. For example, this step may not be performed when the downhole tool 12 uses LWD measurements because all azimuthal angles are obtained by the sensors on the LWD downhole tool 12. In contrast, when the downhole tool 12 uses WL measurements and pad-based images are obtained with missing vertical bands, then the processor 30 may perform automatic interpolation for absent image parts. The processor 30 may perform an in-painting or other interpolation technique to fill the missing values in the image to improve the resolution of the image in the frequency domain. That is, pad-based borehole images may include gaps between the pad images, and the processor 30 may fill these gaps between the pad images with image data that is estimate from surrounding existing data (e.g., interpolation, in-painting).

The processor 30 may generate (block 196) a filtered image. Generating the filtered image may include the processor 30 deriving (block 198) sine frequencies along a vertical and horizontal axis. More particularly, the processor 30 may derive v′ from the slope of the line (drawn or automatically detected) and u′ is given by:

u′=Number of lines×Vertical sampling/Corkscrew period (Equation 12)

In some embodiments, v′ and u′ may represent coordinates of the energy bursts or undesirable features in the frequency domain. The processor 30 may convert (block 200) the selected filter strength (data 186) into parameter k and convert (block 202) data in the spatial domain of the image to the frequency domain. The processor 30 may compute (block 204) the filter parameters σ₁ and σ₂ directly on the frequency domain data. Also, the processor 30 may apply the multi-parameter filter (e.g., Ideal, Butterworth, Gaussian) to reduce the appropriate frequency components (e.g., energy bursts) in strength. Further, the processor 30 may transform (block 208) the frequency domain data back to spatial domain data and replace (block 210) the selected image zone by the computed filtered image data. The resulting filtered image may be output (block 212) by the processor 30 for display on the display 36 or it may be output to another computing device (e.g., transmitted to another communicatively coupled computing device). In some embodiments, the processor 30 may store the filtered image on the memory 32 and/or storage 34.

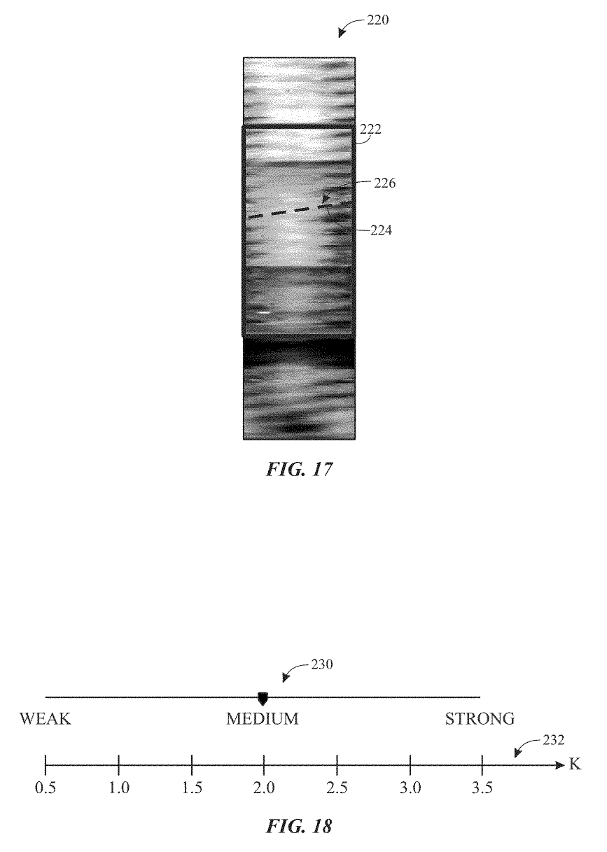

In some embodiments, the user may select a zone on the image (data 188) and may draw at least one line on at least one spiral on the image (data 190), as discussed above. Accordingly, FIG. 17 is an illustration of a resistivity image 220 where the user has selected a zone 222 and drawn a single line 224 on a spiral 226. The processor 30 may derive v′ and u′ from the slope of the drawn line 224. It should be noted that, in some embodiments, more than one line may be drawn by the user and used to derive v′ and u′. Thus, semi-automatic determination of the filter center frequencies in the depth and/or azimuthal directions (e.g., the azimuthal central spatial frequency parameter and the depth-direction central spatial frequency parameter for the filter) may be performed by the processor 30 as a result of user input related to the slope of at least one line (e.g., line 224) drawn on the resistivity image 220 and corresponding to an artifact (e.g., spiral 226) to be filtered from the image 220.

Further, the user may select the strength of the filter using various graphical elements, as shown in FIG. 18. As depicted, the graphical elements used by the user to select the filter strength may include a slider 230. The slider 230 may include a range of values, with “weak” being the lowest value on one end of the range and “strong” being the highest value on the opposite end of the range. The input received from the slider 230 may enable manual adjustable bandwidths in the depth and/or the azimuthal directions. The processor 30 may convert the selected filter strength (data 186) into parameter k 232, as discussed above. Although the filter strength graphical component is shown as a slider 230, it should be appreciated that any suitable graphical element may be used, such as a dropdown list, a textbox, a gauge, radio buttons, or the like.

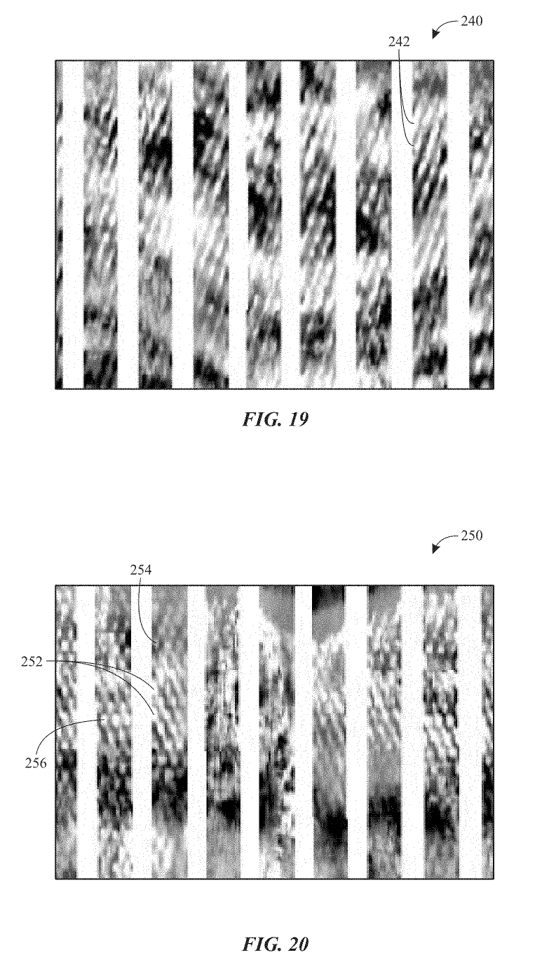

Turning now to the reduction of other artifacts in images, FIGS. 19-21 depict examples of WL borehole images with several types of drill marks, scratch marks, roller-reamer marks, and/or bit marks. The process 180 is the same for substantially removing or reducing the artifacts in that the processor 30 substantially removes or reduces the parts of the spectra of the image in (e.g., in the frequency domain) that correspond to the undesired features.

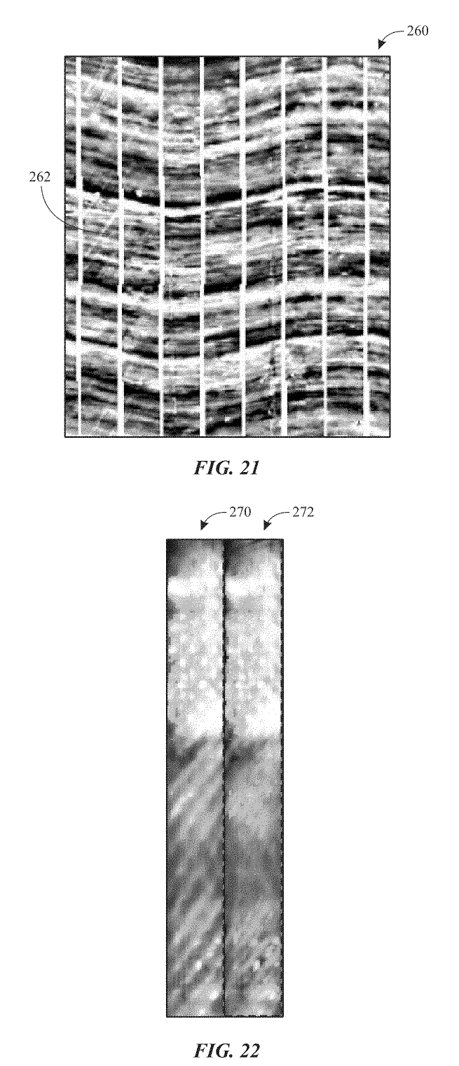

In particular, FIG. 19 is an illustration of pad-based images 240 of a borehole wall including drill marks 242 obtained by the WL downhole tool 12. As depicted, the drill marks 242 are parallel and left-dipping. As may be appreciated, the drill marks 242 may obfuscate certain details of the borehole wall for a user during interpretation. FIG. 20 is an illustration of pad-based images 250 of a borehole wall including drill marks present in two directions (right-dipping drill marks 252 and left-dipping drill marks 254) leading to dots 256 obtained by the WL downhole tool 12. As may also be appreciated, the dots 256 may hinder the interpretation of features of the borehole wall. Further, FIG. 21 is an illustration of pad-based images 260 of a borehole wall including weak scratch marks 262 on just one side of the borehole wall obtained by the WL downhole tool 12. The scratch marks 262, too, may inhibit the ability of a user to interpret features of the borehole wall.

As FIGS. 19-20 illustrate, drill marks and scratch marks come in various forms depending on the penetration speed at drill time, the bit used, the mechanical formation parameters, etc. Some common characteristics of drill marks are a repetitive pattern, a small scale (e.g., neighboring marks can be separated by ˜0.3 inch to ˜3 inch), often, but not always slanted in the same direction across all the affected pads, sometimes ‘double’ drill mark patterns occur, one pattern slanted bottom-left-to-top-right overlays another slanted top-left-to-bottom-right (leading to regular dot-patterns).

FIG. 22 is an illustration of a pad image 270 obtained by the WL downhole tool 12 before and after drill marks are filtered (filtered image 272) using the process 180, in accordance with an embodiment. The filter that has been implemented is based on two-dimensional Fourier transformation of the data. The filter is applied per pad image which allows filtering on just certain sides of the borehole or on certain pad images. Every vertical image strip is generated by a single pad of an eight pad WL downhole tool 12.

In particular, the processor 30 may receive input (user or automatic) of a small interval of the image 270 (e.g., from one pad). The processor 30 may apply a 2D Fast Fourier Transform (FFT) to the interval to convert the image 270 to the frequency domain. Also, the processor 30 may select a small group of frequency components to remove based on the direction of the drill marks and the distance between subsequent drill marks. The processor 30 may receive input (user or default) of the strength of the filter and replace the appropriate frequency components by a strength-based weighted sum of interpolated neighboring non-filtered components and the original components. As discussed above, the filter strength (e.g., a filter strength parameter for the filter) may be adjustable to prevent complete removal of part of the spectrum in the frequency domain. Further, the processor 30 may perform Inverse Fast Fourier Transform (IFFT). Additionally, the processor 30 may replace the original interval of the image 270 with the filtered section, resulting in the filtered image 272. As depicted, the drill marks are substantially removed and features of the borehole wall are much more ascertainable.

It should be noted that the strength of the filter may be user selected or it may be a default value (e.g., a single fixed predefined value). Further, the strength-based weighted sum may be such that the replacement uses the interpolated neighboring non-filtered components, thereby substantially removing or reducing the original components. In some embodiments, the harmonics of the primary frequencies in the frequency domain may be filtered to substantially remove or reduce the undesirable features.

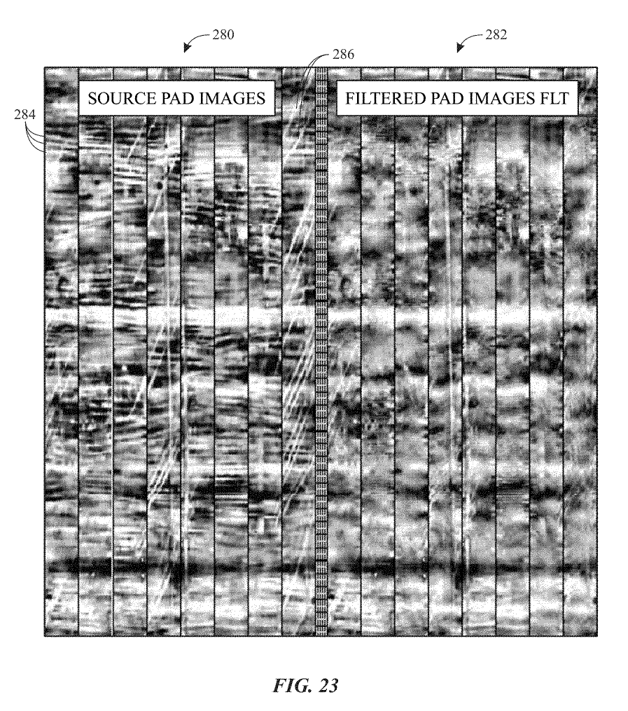

To further illustrate the beneficial features of the present disclosure, FIG. 23 is an illustration of pad-based images 280 obtained by the WL downhole tool 12 before and after two types of drill marks are filtered (filtered images 282), in accordance with an embodiment. As depicted, a first type of drill marks are nearly horizontal stripes 284 and a second type of drill marks are high angled stripes 286. After filtering out the both types of drill marks 284 and 286 using the process 180, the resulting filtered image 282 provides a borehole wall with much more ascertainable features for interpretation.

The specific embodiments described above have been shown by way of example, and it should be understood that these embodiments may be susceptible to various modifications and alternative forms. It should be further understood that the claims are not intended to be limited to the particular forms discloses, but rather to cover modifications, equivalents, and alternatives falling within the spirit of this disclosure.

1. A computer-based method comprising:
obtaining a first image, wherein the first image includes one or more patterns;
generating a second image that substantially removes or reduces the one or more patterns from the first image at least partially by:
detecting the one or more patterns and a zone where the one or more patterns occur in the first image;
converting at least a portion of the first image to frequency domain data;
applying a multi-parameter filter to the frequency domain data to substantially remove or reduce the one or more patterns, wherein a first parameter of the multi-parameter filter relates to a bandwidth in a depth direction and a second parameter of the multi-parameter filter relates to a bandwidth in an azimuthal direction, and the first parameter, the second parameter, or both are adapted in the multi-parameter filter based on the one or more patterns; and
transforming the frequency domain data to spatial domain data; and
outputting the second image based at least in part on the spatial domain data.

2. The method of claim 1, wherein the first image comprises a borehole image deriving from a downhole tool in a wellbore of a geological formation.

3. The method of claim 1, wherein the one or more patterns comprise a corkscrew signature, a drill-mark signature, dots, stripes, triangles, circles, squares, zig-zags, or some combination thereof.

4. The method of claim 1, wherein detecting the one or more artifacts comprises scanning different possible angles of the one or more artifacts to identify pixels in the frequency domain data where the one or more artifacts occur.

5. The method of claim 1, wherein detecting a zone where the one or more artifacts occur in the first image comprises performing peak detection to compute a probability of a likelihood of the one or more artifacts occurrence and identifying the zone where the one or more artifact occur based on the probability.

6. The method of claim 1, wherein converting the first image to frequency domain data comprises computing a discrete fourier transform based on the first image.

7. The method of claim 1, wherein the multi-parameter filter comprises an Ideal filter, a Butterworth filter, or a Gaussian filter.

8. The method of claim 1, wherein the multi-parameter filter comprises a third parameter related to azimuthal central spatial frequency, a fourth parameter related to depth-direction central spatial frequency, a fifth parameter related to filter strength, or some combination thereof.

9. The method of claim 1, wherein transforming the frequency domain data to spatial domain data comprises computing an Inverse Discrete Fourier Transform or an Inverse Fast Fourier Transform based on the frequency domain data.

10. The method of claim 1, applying the multi-parameter filter to the frequency domain data to substantially remove or reduce the one or more patterns comprises filtering harmonics of primary frequencies of the one or more patterns from the frequency domain data.

11. The method of claim 1, comprising receiving a filter strength and adjusting the multi-parameter filter based on the filter strength.

12. The method of claim 1, wherein the one or more artifacts are automatically detected, the zone where the one or more artifacts occur in the first image is automatically detected, the first parameter, the second parameter, or both are automatically adapted in the multi-parameter filter based on the one or more patterns, or some combination thereof.

13. A system, comprising:
a downhole tool in a wellbore of a geological formation; and
a data processing system comprising a processor configured to:
obtain a borehole image deriving from the downhole tool, wherein the borehole image includes one or more artifacts;
generate a filtered image that substantially removes or reduces the one or more artifacts from the borehole image at least partially by:
determining a location of the one or more artifacts and a zone where
the one or more artifacts occur in the borehole image;
converting the borehole image to frequency domain data;
applying a multi-parameter filter to the frequency domain data to substantially remove or reduce the one or more artifacts; and
transform the frequency domain data to spatial domain data; and
output the filtered image based at least in part on the spatial domain data.

14. The system of claim 13, wherein determining a location of the one or more artifacts comprises receiving input of at least one drawn line that indicates where at least one artifact is located.

15. The system of claim 14, wherein the processor derives coordinates of the one or more artifact in the frequency domain data based on a slope of the at least one drawn line.

16. The system of claim 13, wherein determining a zone where the one or more artifacts occur in the borehole image comprises the processor receiving an input selection of an area where the one or more artifacts occur.

17. The system of claim 13, wherein the processor is configured to derive sine frequencies along a vertical and a horizontal axis of the frequency domain data.

18. The system of claim 13, wherein the multi-parameter filter comprises at least two of a first parameter of relating to a bandwidth in a depth direction, a second parameter relating to a bandwidth in an azimuthal direction, a third parameter related to azimuthal central spatial frequency, a fourth parameter related to depth-direction central spatial frequency, and a fifth parameter related to filter strength.

19. A tangible, non-transitory computer-readable medium storing instructions that, when executed by a processor, cause the processor to:
obtain a borehole image deriving from the downhole tool, wherein the borehole image includes one or more artifacts;
generate a filtered image that substantially removes or reduces the one or more artifacts from the borehole image using at least a multi-parameter notch filter, wherein a first parameter of the multi-parameter notch filter relates to a bandwidth in a depth direction and a second parameter of the multi-parameter notch filter relates to a bandwidth in an azimuthal direction, and the first parameter, the second parameter, or both are automatically adapted in the multi-parameter notch filter based on the one or more artifacts; and
output the filtered image based at least in part on the spatial domain data.

20. The computer-readable medium of claim 19, wherein the multi-parameter notch filter comprises an Ideal filter, a Butterworth filter, or a Gaussian filter.
